(19) United States
(12) Patent Application Publication
(10) Pub. No.: US 2023/0417592 A1
(43) Pub. Date: Dec. 28, 2023

(54) Hair Color Mixer

(71) Applicant: Badri Kermani, San Diego, CA (US)

(72) Inventor: Badri Kermani, San Diego, CA (US)

(21) Appl. No.: 17/846,525

(22) Filed: Jun. 22, 2022

(51) Int. Cl. G01G 17/06

(52) U.S. Cl. CPC G01G 17/06

(57) ABSTRACT

Apparatus and methods for accurate measuring and mixing of hair color products that may comprise a machine into which a stylist may insert their color tubes and precisely measure the necessary quantity of color into integrated a color mixing bowl.

### CROSS-REFERENCES TO RELATED APPLICATIONS

Not Applicable.

### FIELD OF INVENTION

The present invention relates generally to an apparatus that use in relation to haircare and hair styling. More particularly, the present invention is related to the accurate measuring and mixing of hair color products.

### BACKGROUND OF THE INVENTION

Currently, in order to determine the proper mixer and quantity of hair color to match a client's hair color preferences, hair stylists must rely on their best professional estimates when measuring hair color. This process can lead to inconsistent results, disappointed customers, and wasted hair color.

There exists a need to streamline the mixing and measuring of color products used in hair dyeing.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

The present invention is directed towards apparatus and methods for accurate measuring and mixing of hair color products. Embodiments of the present invention may comprise a machine into which a stylist may insert their color tubes and precisely measure the necessary quantity of color into integrated a color mixing bowl.

In some embodiments of the present invention a dial knob may allow a stylist to dispense the correct amount of color into the mixing bowl. In some embodiments the correct amount may be precisely measured via a digital scale integrated into the apparatus such that color may be dispensed until the desired weight is reached. In some embodiments the desired weight and/or the current detected weight may be shown on a small digital screen on the device.

Some embodiments may further include an automated color mixing function that enables mixing of the hair color in the same bowl as used of measuring the color components. The mixing bowl can then be removed from the apparatus to hold the color as the stylist applies it to a customer's hair.

Embodiments of the present invention may further comprise a companion mobile application which may enable stylists to mix, measure, and record accurate color information for their clients. There are also products that would mix the colors.

### BRIEF DESCRIPTION OF THE DRAWINGS

The present invention is described in detail below with reference to the attached drawing figures, wherein:

FIG. 1 provides an illustrative view of an exemplary embodiment in accord with aspects of the present invention.

FIG. 2 provides an illustrative view of an exemplary embodiment in accord with aspects of the present invention.

FIG. 3 illustrates a computer system adapted according to certain embodiments of the server and/or the user interface device.

FIG. 4A is a block diagram illustrating a server hosting an emulated software environment for virtualization according to one embodiment of the disclosure.

FIG. 4B is a block diagram illustrating a server hosting an emulated hardware environment according to one embodiment of the disclosure.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

In some embodiments of the present invention a dial knob may allow a stylist to dispense the correct amount of color into the mixing bowl. In some embodiments the correct amount may be precisely measured via a digital scale integrated into the apparatus such that color may be dispensed until the desired weight is reached. In some embodiments the desired weight and/or the current detected weight may be shown on a small digital screen on the device.

The dispenser component may extrude the contents of a hair color tube via precision-actuated compression of the hair color tube.

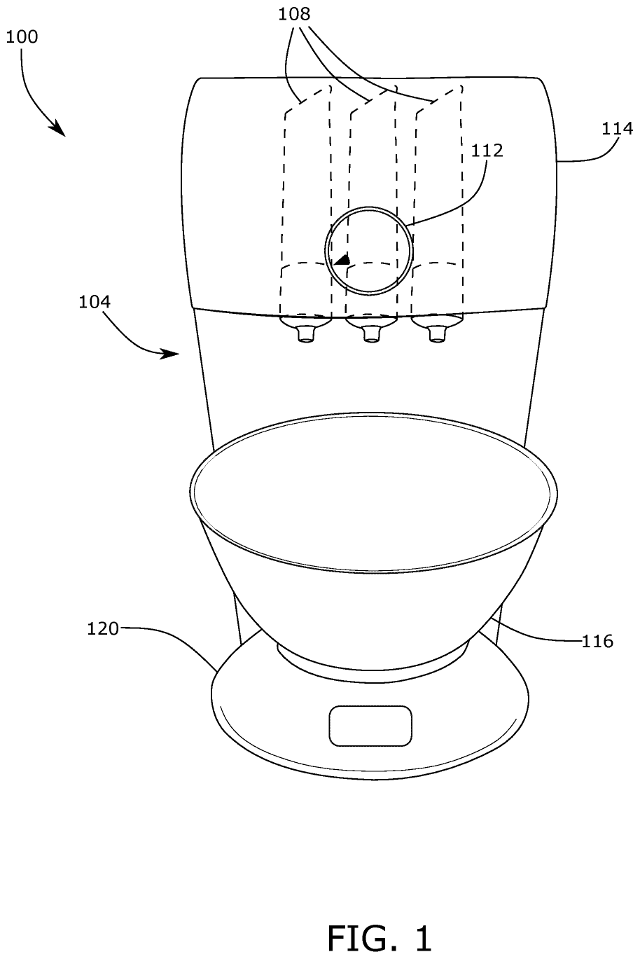

FIG. 1 provides an illustrative view 100 of an exemplary embodiment in accord with aspects of the present invention. As depicted, device 104 includes three hair color tubes 108 inside. Dial knob 112 affixed to dispenser component 114 may allow a user to select a precise quantity of one or more of the hair colors to be dispersed into mixing bowl 116. The weight of the precise quantity of hair color may be measured by scale 120. Weight display 124 may show the amount and/or weight of hair color currently in mixing bowl 116. In some embodiments, measuring a predetermined amount of hair color, as determined by dial knob 112, may cause dispenser component 114 to cease the release of hair color. Additionally and/or alternatively, a predetermined amount of hair color may be set via companion mobile application (not shown).

Some embodiments may further include an automated color mixing function that enables mixing of the hair color in the same bowl as used of measuring the color components. The mixing bowl can then be removed from the apparatus to hold the color as the stylist applies it to a customer's hair.

While the present invention is described in terms of its application in measuring and mixing precise quantities of hair dye from tubes, one having skill in the art will recognize that such an apparatus may be employed with tubes containing other products and substances including but not limited to paste, epoxy, other compound binding agents, tubes for food products such as tomato paste, anchovy paste, pâtés, purees and the like.

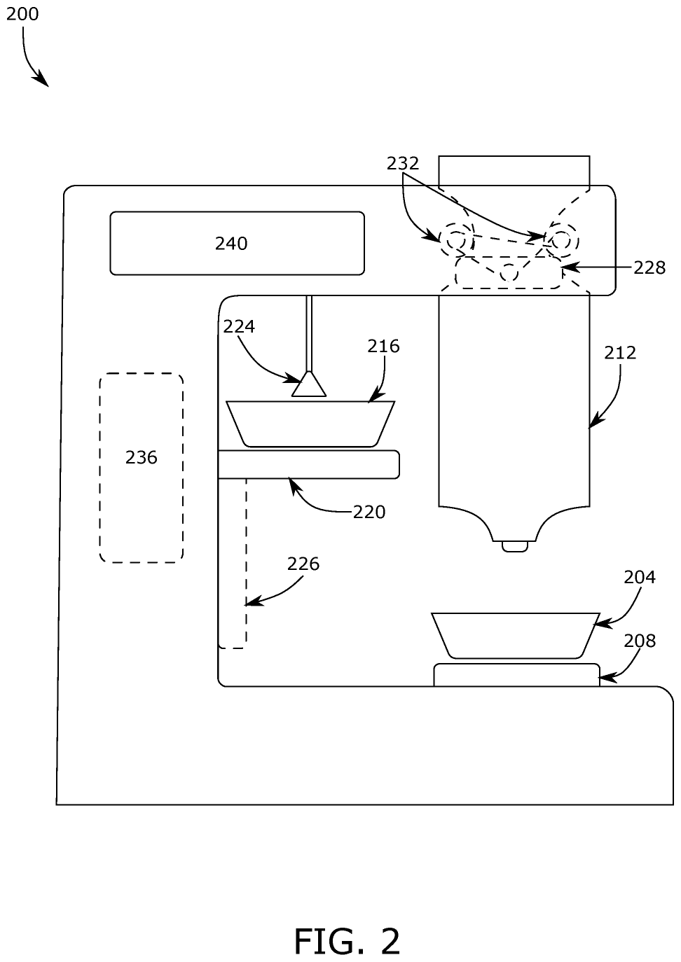

FIG. 2 provides an illustrative view 200 of an exemplary embodiment in accord with aspects of the present invention. As depicted, bowl 204 sits atop integrated digital scale 208. Color tube 212 is positioned above bowl 204 to dispense color into bowl 204. Bowl 216 is positioned atop bowl platform 220. Brush 224 may be lowered into bowl 216 to mix hair colors placed therein. When not is use and/or when positioning bowl 216 under brush 224, bowl platform 220 can be stowed in storage position 226. Motor 228 drives rollers 232, squeezing color tub 212 and dispensing color. Microprocessor 236 provides various computational functionality, including but not limited to wireless communication and data transmission. One having skill in the art will recognize that various wireless communication may be used, including but not limited to Bluetooth, Wi-fi, 5G, and the like or a combination thereof.

Digital display 240 can provide various information including but not limited a timer, power status of the device, reading from digital scale 208, wireless connectivity status, and the like or any combination thereof.

Embodiments of the present invention may further comprise a companion mobile application which may enable stylists to mix, measure, and record accurate color information for their clients. There are also products that would mix the colors.

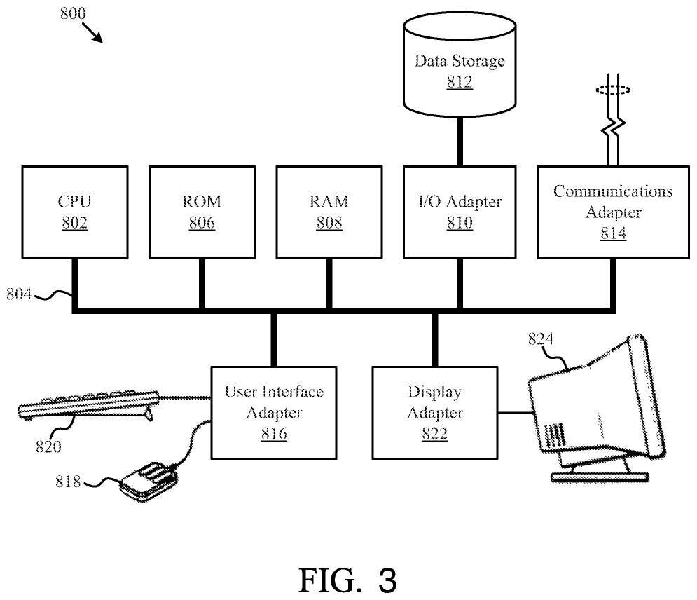

FIG. 3 illustrates a computer system 800 adapted according to certain embodiments of the server and/or the user interface device. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 also may include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The communications adapter 814 may also be adapted to couple the computer system 800 to other networks such as a global positioning system (GPS) or a Bluetooth network. The user interface adapter 816 couples user input devices, such as a keyboard 820, a pointing device 818, and/or a touch screen (not shown) to the computer system 800. The keyboard 820 may be an on-screen keyboard displayed on a touch panel. Additional devices (not shown) such as a camera, microphone, video camera, accelerometer, compass, and or gyroscope may be coupled to the user interface adapter 816. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

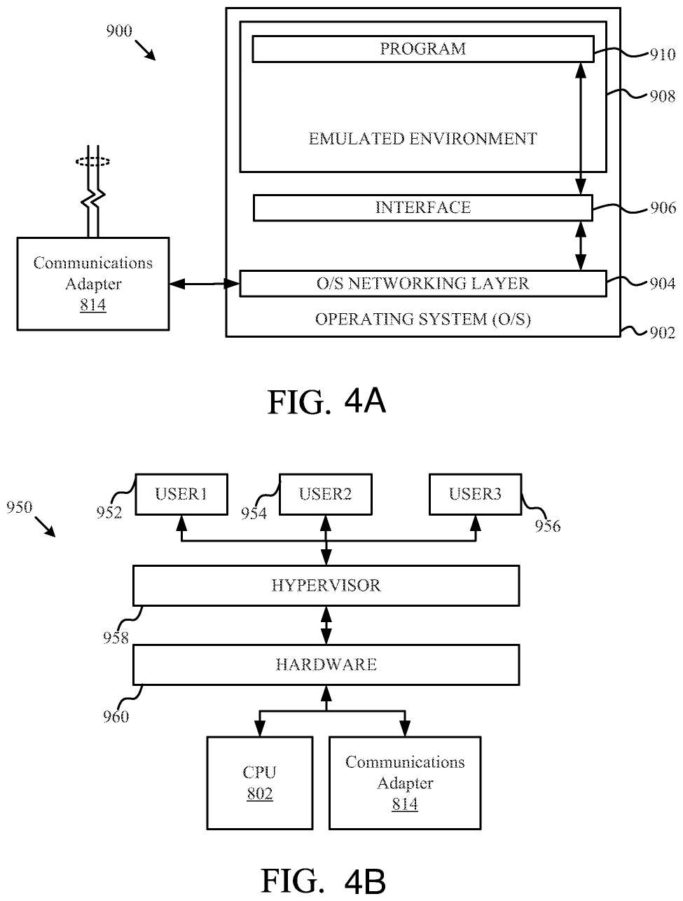

FIG. 4A is a block diagram illustrating a server hosting an emulated software environment for virtualization according to one embodiment of the disclosure. An operating system 902 executing on a server includes drivers for accessing hardware components, such as a networking layer 904 for accessing the communications adapter 814. The operating system 902 may be, for example, Linux. An emulated environment 908 in the operating system 902 executes a program 910, such as CPCommOS. The program 910 accesses the networking layer 904 of the operating system 902 through a non-emulated interface 906, such as XNIOP. The non-emulated interface 906 translates requests from the program 910 executing in the emulated environment 908 for the networking layer 904 of the operating system 902.

In another example, hardware in a computer system may be virtualized through a hypervisor. FIG. 4B is a block diagram illustrating a server hosting an emulated hardware environment according to one embodiment of the disclosure. Users 952, 954, 956 may access the hardware 960 through a hypervisor 958. The hypervisor 958 may be integrated with the hardware 960 to provide virtualization of the hardware 960 without an operating system, such as in the configuration illustrated in FIG. 9A. The hypervisor 958 may provide access to the hardware 960, including the CPU 802 and the communications adaptor 814.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. An apparatus comprising:
a hair dye dispenser having a dial knob,
wherein the dial knob is configured to specify a precise quantity of one or more hair dyes;
a digital scale configured to measure the precise quantity of one or more hair dyes by weight; and
a mixing bowl configured to receive the precise quantity of one or more hair dyes,
wherein the mixing bowl in enable to automatically mix the one or more hair dyes.
